(19) United States
(12) Patent Application Publication
(10) Pub. No.: US 2012/0054020 A1
(43) Pub. Date: Mar. 1, 2012

(54) MANAGING ADVERTISING CAMPAIGNS

(75) Inventor: Philip Jacobs, Windham, NH (US)

(73) Assignee: Cisco Technology, San Jose, CA (US)

(21) Appl. No.: 12/868,556

(22) Filed: Aug. 25, 2010

(51) Int. Cl. G06Q 30/00

(52) U.S. Cl. 705/14.42

(57) ABSTRACT

In one implementation, a campaign manager sends content including advertising related to an advertising campaign to two or more media formats or media types. A consumer engagement score is derived from the user engagement scores associated with the media formats or media types. The consumer engagement score is compared with a target engagement score to determine whether and how to continue the advertising campaign with the particular consumer or set of consumers. Tracking of the advertising campaign extends across media types such as digital television, mobile devices, and personal computers, and extends across formats such as live content, recorded content, interactive content, text messaging, and others.

### FIELD

The present embodiments relate to advertising decisions.

### BACKGROUND

In general, the performance of an advertising campaign is measured and those measurements are compiled only after the advertising campaign has occurred. The results of the measurements affect only future advertising campaigns. Two options available to advertisers for determining suitable advertising strategies and budgets for dividing up advertising resources among various outlets include single source systems and synthesis systems.

In a single source system, a panel of compensated people record all of the types of advertising among various media that they encounter. For example, a panel member may report viewing a particular magazine advertisement, a particular television commercial, or a particular internet banner. Subsequently, the panel member will complete a survey regarding the member's propensity to buy the advertised product or otherwise be influenced by the advertising. Similarly, in a synthesis system, panel members are assigned to different media. For example, one person records exposure to internet advertising and another person records television advertising. Statistics are used to interpolate the likelihood of a positive response in mixed campaigns. In both cases, this information is used to design future advertising campaigns. Based on the surveys and statistical analysis, advertisers choose a mix of advertising that for the industry, will get the best kind of results.

### BRIEF DESCRIPTION OF THE DRAWINGS

FIG. 1 illustrates a block diagram of an advertising system.

FIG. 2 illustrates one implementation of the advertising system of FIG. 1.

FIG. 3 illustrates a campaign manager.

FIG. 4 illustrates a flow chart of advertisement campaign management using target engagement scores.

FIG. 5 illustrates a flow chart of advertisement campaign management using story advertisements.

FIG. 6 illustrates a target engagement pattern for an advertisement campaign.

FIG. 7 illustrates a flow chart of advertisement campaign management using target engagement scores.

### DETAILED DESCRIPTION OVERVIEW

Advertisers may individually tailor advertisements to specific recipients. For example, the avid golfer sees golf club advertisements on the Golf Channel and on golf related websites. In addition, usage of digital television systems, the internet, and mobile consumption devices may be tracked so that advertisers reach the avid golfer when he watches television on another channel, reads email, or plays a game on a mobile phone. An advertisement system may be configured to track engagement of content across many types of media to synthesize a single metric of “equivalent engagement.” Engagement may be classified into a range, from low engagement such as a case where the consumer immediately tunes away from or skips an advertisement, to high engagement such as a case, in which the consumer both views the advertisement and takes a related affirmative action.

The equivalent engagement metric may be used to track and control advertising content engagement across media and across formats. For example, control across media may involve placing an advertisement on television for a particular consumer based on a previous engagement of that consumer of a related advertisement on a personal computer or a mobile device. In addition, control across formats may involve placing an advertisement during a video on demand viewed on television by a particular consumer based on a previous engagement of that consumer of a related advertisement on linear (live) television.

The advertisement system may keep a running total of how much the consumer has engaged with a particular advertising campaign across multiple formats and multiple media, and cease targeting the consumer when the total reaches a predetermined level. A campaign manager sets the high level goals for the advertising campaign, which may include the targeted audience and context. An advertisement decision system receives directives from a campaign manager and selects the content for the individual advertising opportunities. In addition, the equivalent engagement metric is a measure of the success of an advertising campaign across multiple formats and/or across multiple media.

In one aspect, a method includes sending a first advertising content to a first consumption device using a first media type and a second advertising content to a second consumption device using a second media type different than the first media type, tracking consumer engagement as a first engagement score associated with the first media type and the first advertising content and a second engagement score associated with the second media type and the second advertising content, calculating a consumer engagement score, using a controller, from at least the first engagement score and the second engagement score, and selecting additional content based on the consumer engagement score.

In a second aspect, an apparatus includes an interface configured to send a first content in a first media format and a second content in a second media format and receive measurement data indicating consumer engagement of the first media format as a first engagement score and indicating consumer engagement of the second media format as a second engagement score, and a controller configured to calculate a consumer engagement score from at least the first engagement score and the second engagement score and select a third content based on the consumer engagement score.

In a third aspect, logic encoded in one or more non-transitory tangible media is executable by a processor and operable to track consumer exposure to an advertising campaign, the tracked consumer exposure being in multiple formats, types of media, or both formats and types of media, calculate an engagement score based on the consumer exposure for each of the multiple formats, types of media, or both formats and types of media, wherein the calculation is a function of feedback from at least one measurement device detecting responses of a consumer, and transmit additional advertising to the consumer when the scoring does not reach a target engagement score.

### Example Embodiments

Traditional advertising delivers the same message to a mass audience with little focus or control of the recipient. Anyone who drives a particular highway sees the same billboard. Anyone who watches a particular television station sees the same commercial. Geographically placed advertisements in radio and television have long been the norm. Radio stations and television stations insert local advertisements into the media stream received from the network. Soon after the Internet boom, website advertisers realized that individually targeted advertisements were possible. Such directed advertising may increase the effectiveness of advertising. The more traditional media outlets, such as television and radio, raced to catch up.

Recently, the Digital Video Subcommittee (DVS) of the Society of Cable Telecommunications Engineers (SCTE) approved a new standard, SCTE 130 published August 2008 and available at http://www.scte.org, that provides the framework for advertisements through cable television to be tailored to the individual. The SCTE 130 standard provides the protocols and messaging capabilities necessary for advertisers to implement replacement advertisements, pause advertisements, and telescope advertisements. Replacement advertisements splice in a new advertisement over an existing advertisement. Pause advertisements are displayed when the consumer pauses programming. Telescope advertisements include an interactive element that allows the consumer to request additional information. However, the SCTE 130 standard addresses one type of media, cable television, and is not related to calculating consumer engagement across formats or across media types.

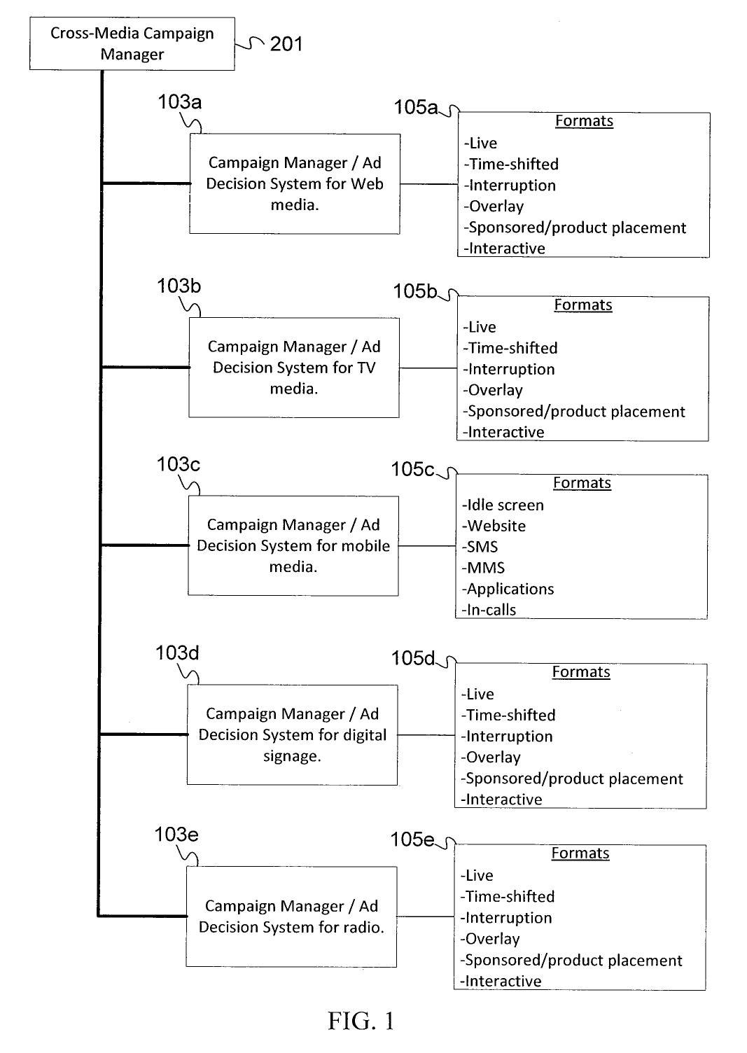

FIG. 1 is a high level block diagram of an advertising system configured to manage advertising campaigns across formats and/or across media. The advertising system includes a cross-media campaign manager 201 and at least one per-media campaign manager 103a-e for each medium. The media may include any medium capable of two-way communication. Two-way communication means that the advertising reaches the viewer and information relating to the viewer is able to be reach the advertising system. Examples of media capable of two-way communication include Internet, television, mobile devices, digital signage, radio, or smart packaging. Two-way communication between the consumption device and the provider enables measurement and identification of the viewer or viewers. Identification of the viewer need not be absolutely certain. Examples of identification devices include biometrics, passwords, wireless smart cards, radio frequency identification, and other methods. The identification may be of a cohort of people, for example all those in a household or defined geographic location, etc.

Two-way communication may also be possible where the consumption of the advertising content occurs in one medium and the measurement of the engagement occurs in another medium. For example, a viewer of a television advertisement may engage another medium is response to the television advertisement. The television advertisement may pique the interest of the viewer, who within a predetermined time period, engages a website regarding the subject matter of the television advertisement.

The provider sends content to the consumer and also receives feedback based on whether than content was viewed or otherwise engaged with by the consumer. Some media types, such as indirectly connected media, may not be capable of real time two-way communication, and may store information regarding the consumer engagement in a memory, which will be uploaded at a time when communication between the consumption device and the provider is established.

The cross-media campaign manager 201 and per-media campaign managers 103a-e may be combined or operate separately, such as the cross-media campaign manager 201 also implementing one or more of the per-media campaign managers 103 or such as one or more of the per-media campaign managers 103 being combined into a fewer number than types of media (e.g., one campaign manager for television, local phone, and Internet provided by the same cable company) or one or more of the per-media campaign managers 103 being divided into a larger number than types of media by format (e.g. one campaign manager for live television and another for time-shifted television). It can be seen that cross-media campaign manager 201 and per media campaign managers 103 comprise a flexible hierarchy.

Each of the per-media campaign managers 103a-e may include an advertisement decision system (ADS) corresponding to one or more formats 105a-e. A format is any scheme for displaying information by a media type. It includes the mode of delivery, for example, in visual media, moving or still pictures may be presented either live (streaming) or in a time-shifted (viewer recorded, on demand, etc.) manner. It also includes the advertisement type, for example, “interruption” type advertisements where the ad takes over the picture of the current program, or “overlay” type advertisements where the advertisement is overlaid over part of the picture. Other media formats include product placement advertisements, or interactive advertisements (such as telescope advertisements). In addition or in the alternative, some media, such as mobile device media, may be configured for formats including idle screen advertisements, websites, short message service (SMS) or another type of text messaging, multimedia messaging service (MMS), application embedded advertisements (advertisements displayed in a game or other application running on the mobile device), or in-call recordings or displayed advertisements. An ADS could handle advertisement selection for any format, i.e. any mode of delivery and advertisement type combination.

In one embodiment, the advertising system controls advertising campaigns through the use of an engagement score. The engagement score is a metric that tracks advertising engagements across media and/or across formats. Since the form of consumer engagements with advertisements across media and/or formats may differ, the engagement score indicates relative equivalency between media and/or formats as an equivalent engagement score. An advertising campaign includes a target equivalent engagement score, which is set in the cross-media campaign manager. The cross-media campaign manager 201 sends the target equivalent engagement score and the campaign rules to the per-media campaign managers 103. The per-media campaign managers 103 keep track of consumer engagements associated with respective media and report back to the cross-media campaign manager 201. The per-media campaign managers 103 may be associated with a particular consumer or a set of consumers. The cross-media campaign manager 201 correlates reported engagements across media and updates the equivalent engagement score.

The advertisement decision systems drive advertisement decisions based on the equivalent engagement score. The advertisement decision systems determine which campaign advertisement to place for a given advertising opportunity based on multiple campaigns contracted and optional information, cause the presentation of the selected advertisement to the consumer, and communicates the resulting advertisement presentation and optionally viewer advertisement engagement status back to campaign managers. Optional information about campaign progress, the viewer, the content and external context may be used to make decisions. External context is anything not related directly to the viewer or content and may include such diverse factors as relative position to other campaign advertisements, weather, stock market, advertiser contract, or advertiser inventory. The advertisement decision system decides what advertisements are shown in real time based on received input from the campaign managers.

For example, an advertising campaign may be designed to send various components of the advertising campaign through multiple formats to a particular target audience of consumers until the consumers have been adequately exposed to the advertising campaign. An example target audience may be defined by demographics including people between 18 and 25 years of age, people who have incomes above or below a certain level, households with children, and/or other groups of consumers. The exposure is measured using the equivalent engagement score.

In another example, an advertising campaign may be designed to send the same advertisement periodically until each individual consumer has viewed the advertisement five or another number of times. Frequency capping of this sort may be implemented with a target engagement score five times the value of the equivalent engagement score of the particular advertisement. Alternatively, the scoring may account for the frequency cap using another algorithm without a multiplication function.

In addition, any combination of consumer engagements of media formats and media types may be combined to provide the target engagement score. When the target engagement score is reached, alternative content is selected for the consumer. The various advertisements of the advertising campaign contribute to the equivalent engagement score in varying degrees, which is described in more detail below.

The target engagement score may also change in time. For example, an advertisement campaign may set the target engagement score at one level for a first time period and a second level for a second time period. The target engagement score may be increased in the time leading up to an event. For example, the advertising campaign for an upcoming feature film may include a target engagement score of 2 for week 1, a target engagement score of 7 for week 2, and a target engagement score of 15 for week 3 during the time leading up to the release of the film.

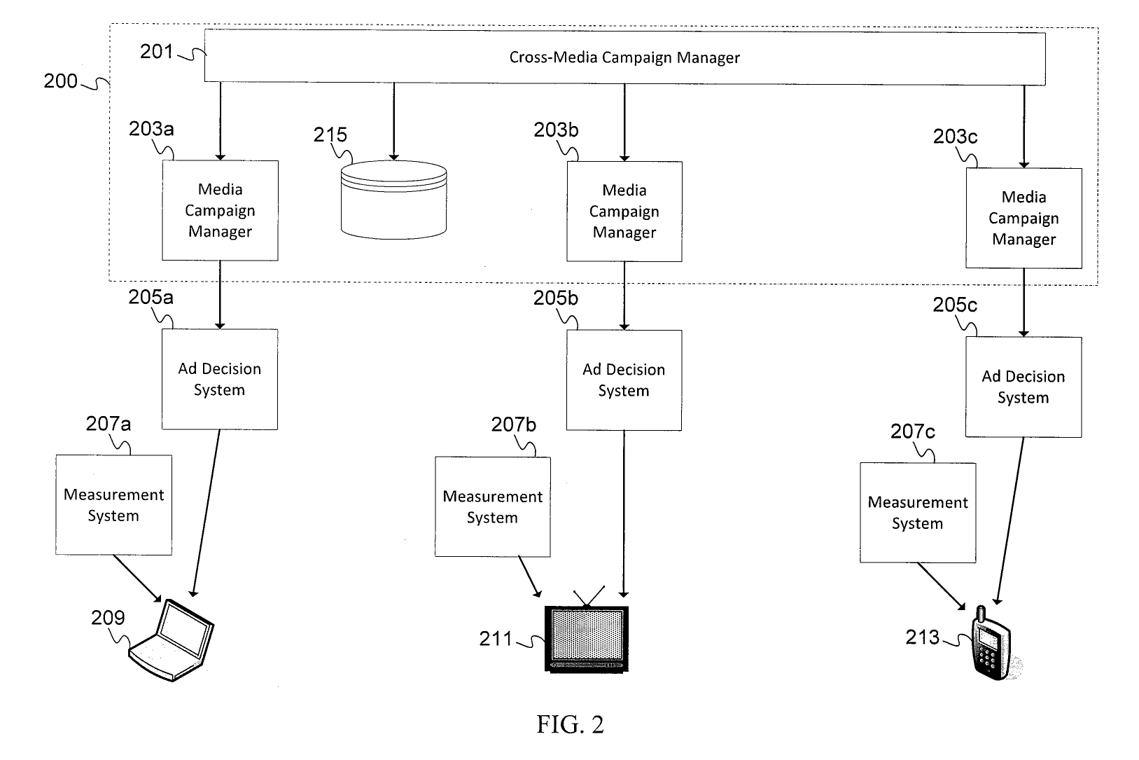

FIG. 2 illustrates another implementation of an advertising system configured to manage advertising campaigns across formats and/or across media. The advertising system includes hierarchical campaign manager 200, advertisement decision systems 205a-c, and measurement systems 207a-c coupled with a consumption device. The consumption devices may include a personal computer 209, a television system 211, a mobile device 213, a digital sign, a radio, smart packaging, or another type of advertising capable of providing feedback to the provider. The feedback may be provided in real time or stored and provided with a time delay. The television system 211 may include any combination of a television, a set-top box, a games console, or another device. The mobile device 213 may include a personal digital assistant, a smartphone, a cellular phone, a tablet PC, or another device. Additional, different, or fewer advertisement decision systems 205 and measurement systems 207 may be used, such as providing only one of the advertisement decision systems 205 for use with more than one type of consumption devices 207.

The hierarchical campaign manager 200 includes the cross-media campaign manager 201, per-media campaign managers 203a-c, and a database 215. The database 215 stores the target equivalent engagement score, the current equivalent engagement score and engagement tables for each campaign. The advertisement decision systems 205a-c may be coupled to, or incorporated within, the consumption devices of the consumer or the advertisement decision systems 205a-c may be distributed at the neighborhood or larger zone level. Alternatively, the advertisement decision systems 205a-c may be incorporated with the hierarchical campaign manager.

The measurement systems 207a-c capture the consumer's engagement with the advertisements and also any related consumer behavior such as navigating to an advertiser's web site. They may employ any one or more of a variety of methodologies, which vary according to the whether the medium is Internet, television, mobile devices, digital signage, radio, or smart packaging. For example, regarding a personal computer on the Internet, methodologies include eye-tracking, physical gestures, verbal cues, mouse clicks, time spent or dwell time, web navigation and others. In mobile devices, the consumer engagement may be measured in a similar method to the Internet plus mobile specific measures such as changes in device orientation, device shaking or changes in geographic location, and reported back using the cellular or other wireless technologies. Logins, passwords, or other methods may be used to identify consumers.

In digital television, there is an upstream communication path from the set-top box to the cable provider. The SCTE 130 standard provides for one example of the protocols and messaging used in the upstream communication path. The set-top box can measure consumer time spent with each advertisement, plus when the consumer increases or decreases the volume, activates mute, records, pauses, fast forwards, rewinds, plays and replays, resizes video, interacts with interactive advertisements, program guides or other applications, or changes the channel. The communication path may be a coaxial, fiber optical, satellite, or another delivery system.

In digital signage, cameras and microphones may be used to measure eye gaze, physical gestures, verbal cues or proximity detection may be used to measure the presence of nearby consumers. Cameras or other methods may be used to identify the consumers.

In radio, two-way communication is possible through radio played on smartphones or IEEE 802.11 enabled devices. In addition, data from the measurement system 207a-c may be stored in a memory until the consumption device is in upstream communication with the advertisement decision system 205a-c or hierarchical campaign manager 200. Logins or other methods may be used to identify consumers.

The unit engagement score describe the extent to which a consumer has engaged with the advertising unit both immediately and subsequently. An advertising unit is a particular unit or type of advertisement such as a particular sized banner, or a 30 second television spot, or a pause advertisement. The unit engagement scores may be determined through research, set arbitrarily, set based on desired advertising effects, or otherwise determined. Unit engagement scores are not absolute, they are relative, and are placed within a scale together with unit engagement scores for engagements across media and formats. In addition, feedback may be used during the advertising campaign to modify the unit engagement scores or to select an appropriate score to be used at a given time. For example, the engagement score may change from one play of the advertisement to the next based on the success or viewership of the advertisement, which is provided in real time. The unit engagement score may be modified depending on the goals of the advertising campaign. Table 1 illustrates an example set of unit engagement scores.

TABLE 1

| Engagement | Unit Engagement | |
|---|---|---|
| Index | Score | Example Consumer Engagement |
| E1 | 0.5 | Television 15-second spot, viewed to completion. |
| E2 | 1.5 | Television 30-second spot, viewed to completion, followed |
| | | within 10 minutes by incoming website interaction. |
| E3 | 1.0 | Television 30-second spot, viewed to completion, no |
| | | constraints on leaving early. |
| E4 | 0.8 | Television 30-second spot, viewed to completion, fast- |
| | | forward disabled. |
| E5 | 0.8 | Incoming advertiser web page visit, completed page |
| | | download, two minutes dwell time. |
| E6 | 0.7 | Incoming advertiser web page visit, completed page |
| | | download, 30 second dwell time. |
| E7 | 0.7 | Online 15-second overlay with interactivity not used, |
| | | viewed to completion, fast-forward disabled. |
| E8 | 1.2 | Played sponsored game on mobile for 15 minutes. |
| E9 | 1.1 | Maximized size of 20 second online video interstitial |
| | | advertisement to full screen, viewed to completion. |
| E10 | 0.8 | Watched complete 15 second web video and forwarded to |
| | | 10 friends. |
| E11 | 1.8 | Watched supermarket digital signage for 15 seconds, put |
| | | product in cart. |
| E12 | 1.7 | Interacted with interactive TV advertisement overlay, sent |
| | | bookmark to PC, opened bookmark within predetermined |
| | | time period. |
| E13 | 0.9 | Interacted with advertisement on mobile device, sent video |
| | | to consumer's personal video recorder, watched to |
| | | completion within predetermined time periods. |

The example unit engagement scores above may vary depending on the particular advertising campaign. The equivalent engagement score (EES) may be represented as the sum of the unit engagement scores (UES) using Equation 1, where E1, E2 . . . En are engagements.

EES=ΣUES(E1) . . . UES(En) [Eq. 1]

Other factors may be included in the calculation of the equivalent engagement score. The other factors include decay functions, priming factors, context weights, creativity weights, and additional considerations. Other functions than a sum function may be used, such as a weighted average function and a logic consideration of the number of exposures regardless of score.

Beyond functional summations of unit engagement scores, engagement scores vary over time. Therefore, a running calculation of the current engagement scores (CES) occurs. Following an engagement report from a per-media campaign manager 203 to the cross-media campaign manager 201, the cross-media campaign manager 201 provides updates on the current engagement score to the per-media campaign manager 203s. The current engagement score may be used to drive media, format or other advertisement decisions. The current engagement score could be used by the advertisement decision system of each per-media campaign manager 203 using the SCTE 130 messaging protocols together with campaign management rules to select ads.

Decay functions account for the elapsed time period since previous engagement on a consumer's current engagement level. Engagement scores may be reduced over time using any decay function. Similarly to the unit engagement scores, decay functions may be allocated to specific engagement types and determined by research or otherwise. Equation 2 includes decay functions (D1, D2, etc) for each engagement type, where E1, E2 . . . En are engagements, where Tnow is the current time and T1, T2 . . . Tn are the times of engagements.

CES=Σ[D1(Tnow−T1)·UES(E1)+D2(Tnow−T2)·UES(E2)+ . . . +Dn(Tnow−Tn)·UES(En)] [Eq. 2]

In addition, since the impact of an engagement may depend upon previous engagements, the unit engagement score may be weighted by the consumer's current engagement score at the time Tk of that new engagement, including an influence function (I) describing how previous engagement influenced a unit engagement score. If the consumer previously responded to a given engagement (e.g., Internet banner advertisement), then the engagement score for banner ads may be weighted more heavily than other formats or media. Or if it is found that a 30 second television advertisement is more effective following an internet banner advertisement, then that 30 second television advertisement may be given a higher score following a banner advertisement. An example calculation for an effective unit engagement score (EUES) including the influence factor is shown by Equation 3. The influence function may be determined by research or otherwise set. Equation 4 provides a modified calculation for the current effective engagement score (CEES) including the effects of previous engagements.

EUES=UES(Ek)·CES(Tk)·I(Ek) [Eq. 3]

CEES=Σ[EUES(E1)·D1(Tnow−T1)+ . . . +EUES(En)·Dn(Tnow−Tn)] [Eq. 4]

Priming factors account for previous events that may impact a consumer's engagement with advertising content. This is similar to the effect of previous engagements on a current engagement. For example, non-advertising content in a video stream or playlist may contain scenes which prime the consumer to perceive the subsequent advertising engagement. The effect may be either positive or negative. Analysis of the content identifies events that prime the consumer, and each event is allocated a unit priming score (UPS) and a time decay function (D), which may be determined by research or otherwise set. Equation 5 below is an example calculation for current priming strength (CPS), which may be incorporated into Equations 2 or 4 to account for the influence of priming events on an engagement.

CPS=UPS(PE1)·D(Tnow−Tp) [Eq. 5]

Equation 5 describes the current priming strength (CPS) of a single priming event. The accumulated priming strength of all previous priming events is described by Equation 6, wherein PE1, PE2 . . . PEn are priming events, and Tp1, Tp2 . . . Tpn are the times of the priming events.

CPS=Σ[UPS(PE1)·D(Tnow−Tp1)+UPS(PE2)·D(Tnow−Tp2)+ . . . +UPS(PEn)D(Tnow−Tpn)] [Eq. 6]

The current context may also effect the engagement of the consumer. The unit engagement scores may also be weighted for the context of the engagement. The term context includes what else is present in the media at the time the advertisement is presented, how much clutter is simultaneously displayed in the media, the time of day, the location, current customer activity, and/or other context related information. Context events may be assigned context scores (CXS), which may be determined by research or otherwise set. Context scores may also have varying influence functions (ICX) for various engagements. Equation 6 provides an example calculation for the effect of context scores and respective influence functions on effective unit engagement scores (EUES). The current effective engagement score can be recalculated incorporating context effects.

EUES=UES(Ek)·CES(Tk)·I(Ek)·CSX(Ek)·ICX(k) [Eq. 6]

Creativity weights may also be applied to the unit engagement scores. Creativity weights describe the way in which an advertisement message is perceived by consumers because of the creative way which the message is presented. A creative weighting value (CW) may be allocated differently for each ad unit and media and/or format, which may be determined by research or otherwise set. The creative weighting value may be used to modify the unit engagement score due to creative content. In addition, the level of a match or mismatch between the creativity and the consumer may be allocated for a particular consumer engagement with that content. A match weighting value may be applied to modify the unit engagement score.

Engagement indexes, unit engagement scores, decay functions, priming factors, context weighting, and creating weighting values may be stored within engagement tables or other structures in database 215.

The equivalent engagement score or the current engagement score is determined by campaign manager 200. The campaign manager 200 provides directives to the advertisement decision systems 205a-c to drive advertisement decisions. The advertisement decision systems decide when to continue to send advertisements and which advertisements related to an advertising campaign to an individual or a group of individuals.

For example, consider an advertising campaign targeting a group of ten consumers. The campaign manager 200 sets a target engagement score of 1.5 for each of the consumers, and sends the appropriate directives to the advertisement decision system 205. Each of the ten consumers receives an advertisement via a consumption device, for example a television. The various consumers may receive the advertisement in different formats. Consumer A may view a 30 second advertisement with fast forwarding disabled played within a digital video recording stored on a set top box. Consumer A's measurement system 207 returns an engagement index E4 of 0.8 to the campaign manager 200. Consumer B may view the same or a different 30 second advertisement with no constraints on leaving early, but choose to view the advertisement to completion. Consumer B's measurement system 207 returns an engagement index E3 of 1.0. Consumer C may view the same or a different 30 second advertisement and within a predetermined time visit and a website referenced in the advertisement. Consumer C's measurement system 207 returns an engagement index E2 of 1.5.

The campaign manager 200 determines that consumer C's equivalent engagement score meets or exceeds the target engagement score of 1.5. The campaign manager 200 may instruct the advertisement decision system 205 to stop directing the advertising campaign to consumer C and/or start directing another advertising campaign to consumer C. The campaign manager 200 determines that both consumer A's and consumer B's equivalent engagement score is less than the target engagement score. The campaign manager 200 sends a directive to the advertisement decision system 205 to continue the advertising campaign with both consumer A and consumer B. The advertisement decision system 205 may continue to send advertisements to the consumer A and consumer B in a variety of formats using a variety of media types.

Suppose consumer A subsequently engages a 15 second advertisement overlay to completion with fast-forward disabled using another consumption device, such as a personal computer. Consumer A's measurement system 207 returns an engagement index E7 of 0.7. The campaign manager 200 determines that consumer A's equivalent engagement score (E4+E7=1.5) meets or exceeds the target engagement score of 1.5. The campaign manager 200 may instruct the advertisement decision system 205 to stop directing the advertising campaign to consumer A and/or start directing another advertising campaign to consumer A.

The advertisement decision system 205 continues to send advertisements to the consumption devices of consumer B until consumer B engages with one or more advertisements with a cumulative score equal to or greater than 0.5. For example, suppose consumer B views the same 30 second advertisement with no constraints on leaving early, and again chooses to view the advertisement to completion. Consumer B's measurement system 207 returns an engagement index E3 of 1.0. In one embodiment, the campaign manager may reduce (or otherwise indicate a reduction using an entry in database 215) the engagement index because of the diminishing marginal returns of the same consumer viewing the same advertisement twice. Since the equivalent engagement score (E3+E3=2) of consumer B meets or exceeds the target engagement score of 1.5, campaign manager 200 may instruct the advertisement decision system 205 to stop directing the advertising campaign to consumer B and/or start directing another advertising campaign to consumer B.

In another implementation, the equivalent engagement score may be used to maximize the value of an advertising campaign while minimizing costs. The campaign manager 200 may calculate various costs of the advertisement campaign from the equivalent engagement scores and the costs of each ad unit. As more consumers engage an advertisement campaign across formats or across media, the cost and value of the advertisement campaign increases. In the example above, the campaign manager 200 may incur a higher cost for the advertising campaign delivered to consumer B than to the advertising campaign delivered to consumers A or C because consumer B's equivalent engagement score exceeds that of consumers A or C. The cross media campaign manager may send directives to each media campaign manager to try to meet target engagement goals while minimizing costs. For example, in the example above, a 15 second advertisement may have met the target engagement objective for consumer B rather than a 30 second advertisement.

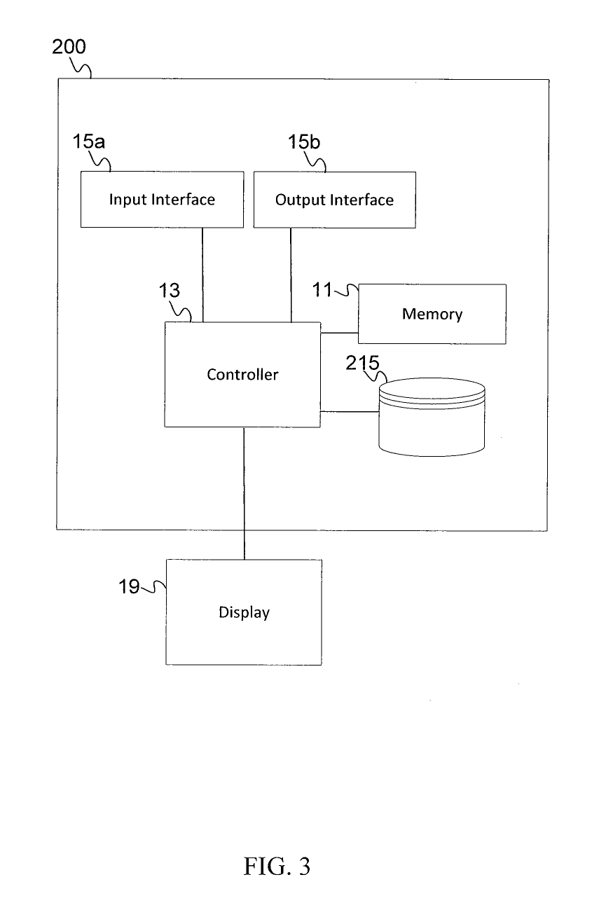

FIG. 3 illustrates the campaign manager 200. The campaign manager 200 may implement any combination of the cross-media campaign manager 201, per-media campaign managers 203a-c, and the advertisement decision systems 205a-c. The campaign manager 200 may be implemented using hardware including a controller 13, a memory 11, database 215, and a communications interface, including an input interface 15a and an output interface 15b. The input interface 15a receives measurements from the measurement system 207a-c. The output interface 15b provides directives to the advertisement decision systems 205a-c. Additional, different, or fewer components may be provided.

The memory 11 may be any known type of volatile memory or a non-volatile memory. The memory 11 may include one or more of a read only memory (ROM), dynamic random access memory (DRAM), a static random access memory (SRAM), a programmable random access memory (PROM), a flash memory, an electronic erasable program read only memory (EEPROM), static random access memory (RAM), or other type of memory. The memory 11 may include an optical, magnetic (hard drive) or any other form of data storage device. The memory 11 may be located in a remote device or removable, such as a secure digital (SD) memory card. The database 215 may be external to the campaign manager 200 or incorporated within the campaign manager 200. The database 215 may be stored with memory 11 or separately.

The memory 11 may store computer executable instructions. The controller 13 may execute computer executable instructions. The computer executable instructions may be included in computer code. The computer code may be stored in the memory 11. The computer code may be written in any computer language, such as C, C++, C#, Java, Pascal, Visual Basic, Perl, HyperText Markup Language (HTML), JavaScript, assembly language, extensible markup language (XML) and any combination thereof.

The computer code may be logic encoded in one or more tangible media or one or more non-transitory tangible media for execution by the controller 13. Logic encoded in one or more tangible media for execution may be defined as instructions that are executable by the controller 13 and that are provided on the computer-readable storage media, memories, or a combination thereof. Instructions for instructing a network device may be stored on any logic. As used herein, “logic” includes but is not limited to hardware, firmware, software in execution on a machine, and/or combinations of each to perform a function(s) or an action(s), and/or to cause a function or action from another logic, method, and/or system. Logic may include, for example, a software controlled microprocessor, an ASIC, an analog circuit, a digital circuit, a programmed logic device, and a memory device containing instructions.

The instructions may be stored on any non-transitory computer readable medium. A computer readable medium may include, but is not limited to, a floppy disk, a hard disk, an application specific integrated circuit (ASIC), a compact disk CD, other optical medium, a random access memory (RAM), a read only memory (ROM), a memory chip or card, a memory stick, and other media from which a computer, a processor or other electronic device can read.

The controller 13 may include a general processor, digital signal processor, application specific integrated circuit, field programmable gate array, analog circuit, digital circuit, server processor, combinations thereof, or other now known or later developed processor. The controller 13 may be a single device or combinations of devices, such as associated with a network or distributed processing. The controller 13 may be responsive to or operable to execute instructions stored as part of software, hardware, integrated circuits, firmware, micro-code or the like. The functions, acts, methods or tasks illustrated in the figures or described herein may be performed by the controller 13 executing instructions stored in the memory 11.

The I/O interface(s) 15a-b may include any operable connection. An operable connection may be one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other or through one or more intermediate entities (e.g., processor, operating system, logic, software). Logical and/or physical communication channels may be used to create an operable connection. For example, the I/O interface(s) 15a-b may include a first communication interface devoted to sending data, packets, or datagrams and a second communication interface devoted to receiving data, packets, or datagrams. Alternatively, the I/O interface(s) 15a-b may be implemented using a single communication interface.

The communication paths between the campaign manager, advertisement decision system, and consumption devices may be any protocol or physical connection that is used to couple a server to a computer. The communication paths may utilize Ethernet, wireless, transmission control protocol (TCP), internet protocol (IP), or multiprotocol label switching (MPLS) technologies. As used herein, the phrases “in communication” and “coupled” are defined to mean directly connected to or indirectly connected through one or more intermediate components. Such intermediate components may include both hardware and software based components.

The campaign manager 200 may also include display 19 and at least one input device. The display may be a cathode ray tube (CRT) monitor, a liquid crystal display (LCD) panel, or another type of display. The input device may be configured to enter the target engagement score into the campaign manager 200. In addition, a user may enter or adjust the unit engagement scores or the other weights and factors discussed above. The input device may include a camera, a microphone, a keyboard, and/or a mouse.

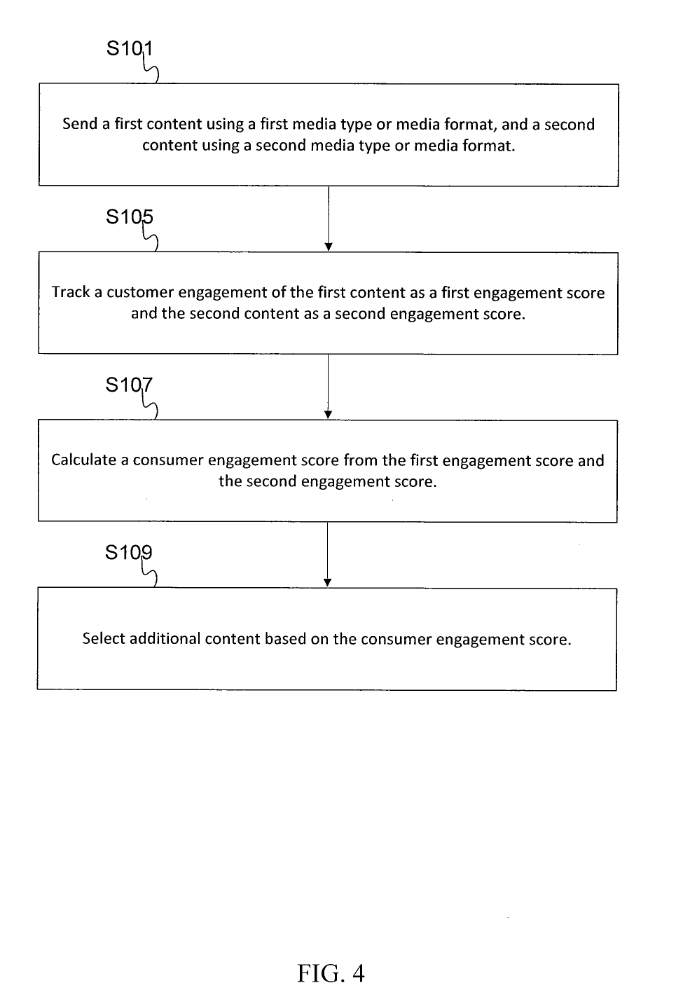

FIG. 4 illustrates a flow chart of an advertisement campaign management using target engagement scores. At S101, the advertisement decision system 205 sends a first content to a first consumption device using a first media type or media format and a second content to a second consumption device using a second media type or media format. The first content and the second content may be sent in any order or concurrently. The first consumption device and the second consumption device may be different types of devices. Example consumption devices include computing devices 209, televisions 211, mobile devices 213, digital signage, and electronic packaging.

At S105, the campaign manager 200 tracks customer engagement as a first engagement score associated with the first content and a second engagement score associated with the second content. The campaign manager 200 may receive measurement data from measurement systems 207. The measurement systems 207 measure the actual interaction of the consumer with the consumption device. The measurement system 207 may detect the actions of the consumer (e.g., clicking past the advertisement or changing the channel) or the presence of the consumer (e.g., proximity or eye gaze). The measurement system 207 may also detect the actions of the consumer across media within a time period on a different medium (e.g., accessing a web page within one week of viewing a related television advertisement.)

At S107, the campaign manager 200 calculates a consumer engagement score, using a controller, from any engagement scores for a given campaign. For example, the consumer engagement score is calculated from the first engagement score and the second engagement score. The campaign manager 200 may compare the consumer engagement score with a target engagement score. The target engagement score describes how much exposure with a particular consumer or class of consumers that the advertiser desires. At S109, the campaign manager 200 selects additional content based on the consumer engagement score. For example, if the target engagement score has not been reached, the first advertisement continues to be delivered to the consumption device, and if the target engagement score has been met or exceeded, the advertisement campaign is ended for that consumer for a predetermined time period. Based on feedback, the advertisement format and/or media for a given campaign may be altered or remain the same in an effort to increase the consumer engagement score.

Another example of an advertisement campaign may include a story advertisement. A story advertisement has several parts. The parts may be sequential such that understanding one part of the story advertisement requires knowledge of the events of one or more previous parts. Some advertisement campaigns may deliver story advertisements by running part one for a first week, the second part for a second week, and so on, and relying on chance that consumers will happen to see each part. Using the advertisement system above, a variety of algorithms could be used to ensure that individual consumers see each part of the story commercial once or a predetermined number of times before proceeding to the next part. This may operate without arbitrary time constraints or may maintain temporal limitations as well.

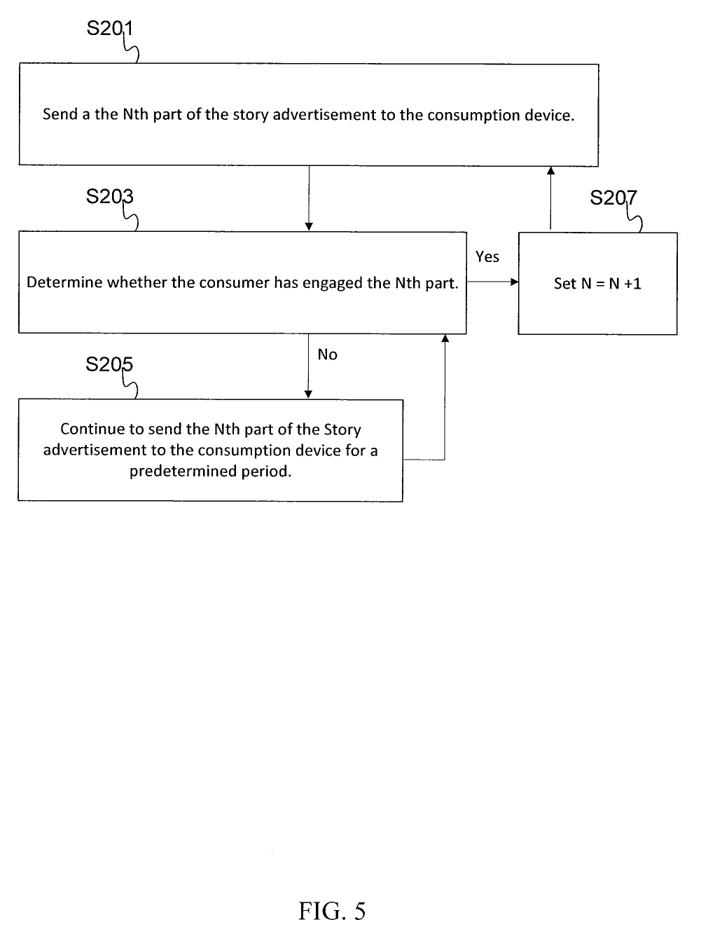

An example algorithm is shown by FIG. 5. At S201, the advertisement decision system 205 sends a first part of the story advertisement to the consumer or class of consumers. At S203, the measurement system 207 determines whether the first part of the story advertisement has been delivered to the consumption device. The measurement system 207 sends measurement data to the campaign 200 indicating that the first part has been engaged by the consumer. If the first part has not been engaged, at S205, the campaign manager 200 continues to send the first part to the consumption device for a predetermined number of times or for a predetermined time period, which is configurable. If the first part has been engaged by the consumer, at S207, the system increments to the second part of the story advertisement. The sequence repeats until all parts, or the specified parts, of the story advertisement has been engaged by the consumer.

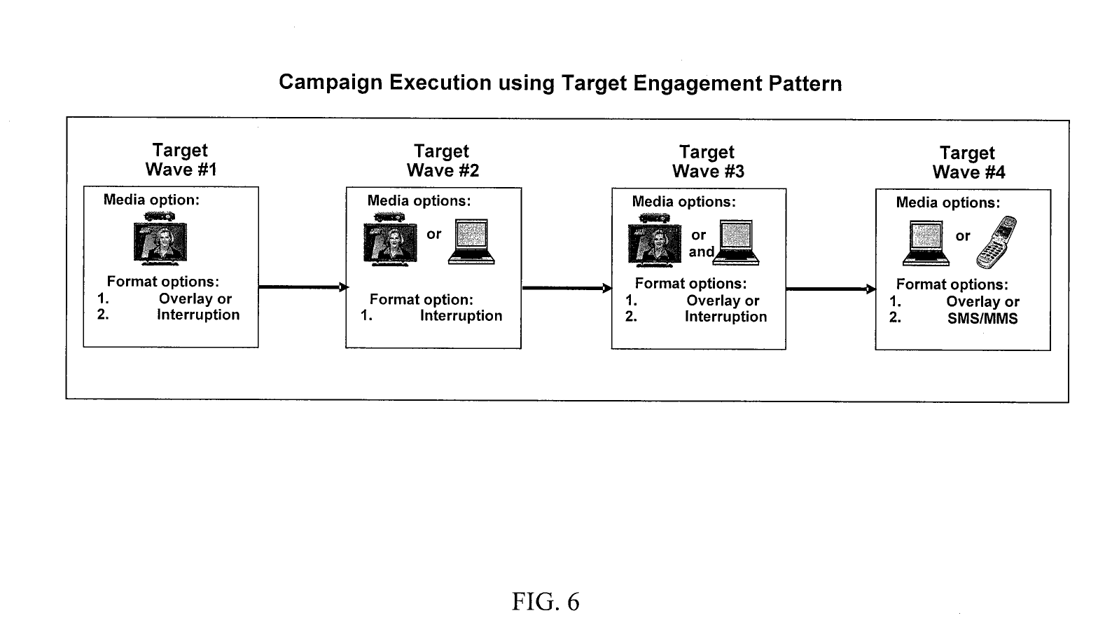

Another example of a sequenced advertisement campaign is a target engagement pattern. FIG. 6 illustrates a target engagement pattern for an advertisement campaign. An advertiser may identify or otherwise define an optimum sequence of advertisements for consumers spanning across various media. An example sequence may include: (1) 30 second advertisement on television, (2) a banner advertisement on a personal computer, (3) one of (3a) a mobile SMS advertisement or (3b) another 30 second television advertisement. Another example sequence, as shown in FIG. 6 may include: (1) the media is television and the format is either overlaid or interrupting live or time-shifted programming, (2) the media is television or personal computer and the format is an interruption advertisement, (3) the media is television or personal computer and the format is either overlaid or interrupting live or time-shifted programming, and (4) the media is personal computer or mobile phone and the format is either overlaid or a SMS/MMS message. Such a sequence may be realized using the directives and priorities sent from the cross media campaign manager 201 to the media campaign managers 203a-c and ad decision systems 205a-c, as discussed above. The cross media campaign manager 201 may also set the time delay between stages in the sequence. Example time delays include one hour, one day, or one week.

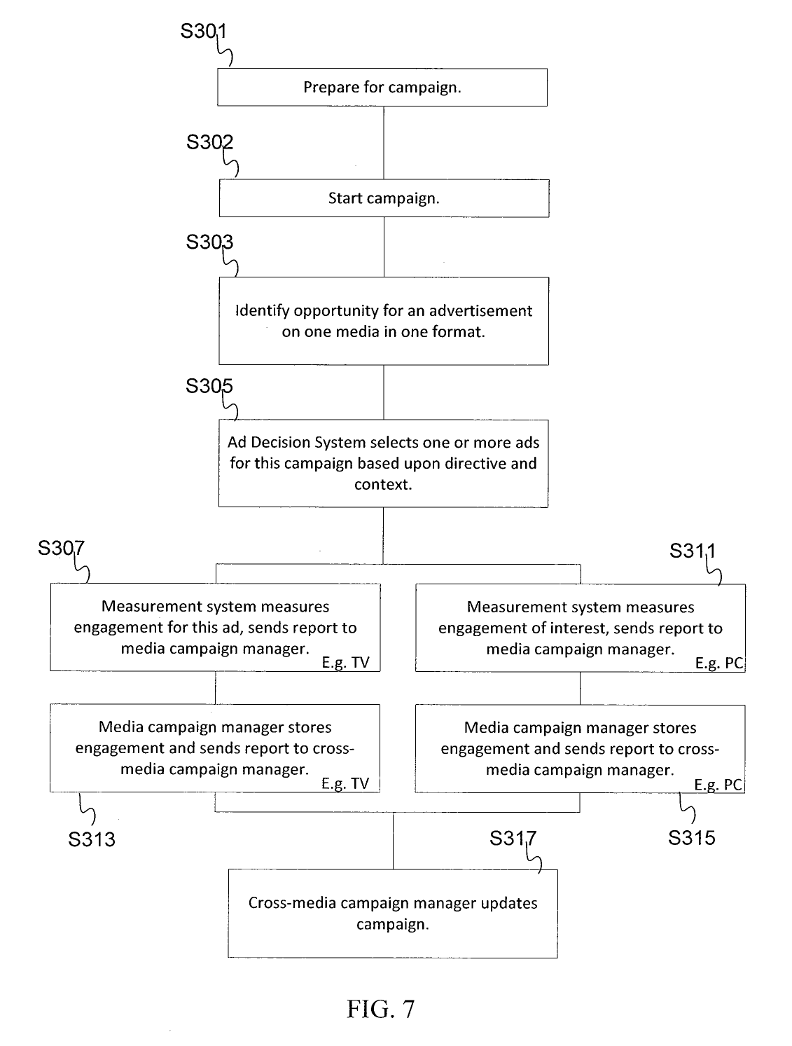

FIG. 7 illustrates a detailed flow chart of advertisement campaign management using target engagement scores. At S301, the cross-media campaign manager 201 prepares for the campaign, which may include determining engagements to be tracked, target engagement scores, algorithms and values, unit engagement scores, and other variables and weights as discussed above. The information may be determined by the cross-media campaign manager 201 or the user may manually enter the information. The cross-media campaign manager 201 sends instructions and directives to the media campaign manages 203a-c and the ADSs 205a-c. At S302, the cross-media campaign manager 201 starts the campaign.

At S303, a particular ADS identifies an opportunity for an advertisement in one format in one media. At S305, the particular ADS selects one or more advertisements for the opportunity using the directives and context received from the media campaign manager 203. The selected advertisements may be sent to one or more media. For example, at S307 an advertisement is sent to a television, at which the corresponding measurement system 207b measures engagement for this advertisement, sends report to media campaign manager 203b. At S311, an advertisement is sent to a personal computer, at which the corresponding measurement system 207a measures engagement of interest and sends a report to the media campaign manager 203a.

At S313 and S315, the media campaign manager 203a and media campaign manager 203b store the engagement and send a report to the cross-media campaign manager 201. At S317, the cross-media campaign manage 201 correlates reports, updates the engagement scores in the engagement tables stored in database 215, and sends revised directives to the media campaign managers 203a-c. The process continues until the end of campaign.

Various embodiments described herein can be used alone or in combination with one another. The foregoing detailed description has described only a few of the many possible implementations of the present invention. For this reason, this detailed description is intended by way of illustration, and not by way of limitation.

I (we) claim:

1. A method comprising:
sending a first advertising content to a first consumption device using a first media type and a second advertising content to a second consumption device using a second media type different than the first media type;
tracking consumer engagement as a first engagement score associated with the first media type and the first advertising content and a second engagement score associated with the second media type and the second advertising content;
calculating a consumer engagement score, using a controller, from at least the first engagement score and the second engagement score; and
selecting additional content based on the consumer engagement score.

2. The method of claim 1, wherein the first engagement score, the second engagement score, the consumer engagement score, and the additional content are related to a first advertising campaign.

3. The method of claim 1, further comprising:
comparing the consumer engagement score to a target score,
wherein if the consumer score is less than the target score, the additional content is related to the first advertising campaign and selected based on the difference between the consumer engagement score and the target score, and
wherein if the consumer score is greater than or equal to the target score, the additional content is related to a second advertising campaign.

4. The method of claim 1, further comprising:
decreasing the first engagement score based on a decay function and a time period elapsed from sending the first content.

5. The method of claim 1, further comprising:
adjusting the first engagement score according to a priming factor based an effect of surroundings on the first media type.

6. The method of claim 1, further comprising:
adjusting the first engagement score according to a context over time, wherein the context is selected from the group consisting of time of day, location of the first content, subject matter of material surrounding the first content, or quantity of subject matter surrounding the first content.

7. The method of claim 1, wherein the first consumption device is selected from the group consisting of a television, a mobile phone, a personal computer, a digital sign, and indirectly connected media.

8. The method of claim 1, wherein the first media type is configured to display the advertising content using at least one of a live stream, a time-shifted recording, an interruption advertisement, an overlaid advertisement, a product placement, and an interactive advertisement.

9. The method of claim 1, wherein the first media type is configured to display the advertising content using at least one of an idle screen display, a website display, a text message, a media message, a local application, and an in-call recording.

10. An apparatus comprising:
an interface configured to send a first content in a first media format and a second content in a second media format and receive measurement data indicating consumer engagement of the first media format as a first engagement score and indicating consumer engagement of the second media format as a second engagement score; and
a controller configured to calculate a consumer engagement score from at least the first engagement score and the second engagement score and select a third content based on the consumer engagement score.

11. The apparatus of claim 10, further comprising:
a consumption device operable to present the first media format and the second media format.

12. The apparatus of claim 10, wherein the controller is further configured to compare the consumer engagement score to a target score, and wherein if the consumer score is less than the target score, the third content is related to a first advertising campaign and selected based on the difference between the consumer engagement score and the target score, and if the consumer score is greater than or equal to the target score, the third content is related to a second advertising campaign.

13. The apparatus of claim 10, wherein the controller is further configured to decrease the first engagement score based on a decay function and a time period elapsed from sending the first content.

14. The apparatus of claim 10, further comprising:
a measurement device configured to generate the measurement data, wherein the measurement data indicates a decision made by a consumer.

15. The apparatus of claim 10, wherein the first media format and the second media format are selected from the group consisting of a live stream, a time-shifted recording, an interruption advertisement, an overlaid advertisement, a product placement, and an interactive advertisement.

16. The apparatus of claim 10, wherein the first media format and the second media format are selected from the group consisting of an idle screen display, a website display, a text message, a media message, a local application, and an in-call recording.

17. Logic encoded in one or more non-transitory tangible media, the logic executable by a processor and operable to:
track consumer exposure to an advertising campaign, the tracked consumer exposure being in multiple formats, types of media, or both formats and types of media;
calculate an engagement score based on the consumer exposure for each of the multiple formats, types of media, or both formats and types of media, wherein the calculation is a function of feedback from at least one measurement device detecting responses of a consumer; and
transmit additional advertising to the consumer when the scoring does not reach a target engagement score.

18. The logic of claim 17, further operable to:
compare the engagement score to the target engagement score,
wherein if the engagement score is less than the target score, the additional advertising is related to the advertising campaign, and wherein if the engagement score is greater than or equal to the target score, the additional advertising is related to a second advertising campaign.

19. The logic of claim 18, wherein the consumer exposure and the measurement device are associated with different media types.

20. The logic of claim 17, further operable to:
adjust the engagement score according to a context over time, wherein the context is selected from the group consisting of time of day, location of the first content, subject matter of material surrounding the first content, or quantity of subject matter surrounding the first content.
